(19) United States
(12) Patent Application Publication
(10) Pub. No.: US 2023/0099755 A1
(43) Pub. Date: Mar. 30, 2023

(54) SQL EXTENSION TO KEY TRANSFER SYSTEM WITH AUTHENTICITY, CONFIDENTIALITY, AND INTEGRITY

(71) Applicant: SAP SE, Walldorf (DE)

(72) Inventors: Subhamay BARUI, Pune (IN); Ramesh GUPTA, Pune (IN)

(21) Appl. No.: 17/483,914

(22) Filed: Sep. 24, 2021

(51) Int. Cl. H04L 9/08; H04L 9/32; H04L 29/06; H04L 9/30

(52) U.S. Cl. CPC H04L 9/0825; H04L 9/3247; H04L 63/0442; H04L 9/302

(57) ABSTRACT

Disclosed herein are various embodiments an SQL extension to key transfer system with authenticity, confidentiality, and integrity. An embodiment operates by generating a key pair including both a target public key and a target private key. The target public key is provided to a source database server, wherein the source database server includes a source secret for unencrypting encrypted data accessible to the target database server. A source public key generated by the source database server and a digital signature signed with a source private key generated by is received from the source database server including an encrypted version of the source secret. The digital signature is verified as being valid. The encrypted version of the source secret is unencrypted using the target private key and the source secret is used to access the encrypted data.

### BACKGROUND

Data is often transferred between different databases for various reasons. For example, data may be transferred from a source server to a target server because of a scheduled data migration, equipment upgrade, or as part of a testing environment. To protect the integrity of the data being transferred, the data may be encrypted using encryption keys. But, in order for the target server to actually access the data, the encryption keys must also be transferred from the source server to the target server. However, simply transmitting the encryption keys over an unsecure network could expose the encryption keys, and as a result the underlying data, to the same security threats which were originally sought to be avoided by encrypting the data in the first place.

### BRIEF DESCRIPTION OF THE DRAWINGS

The accompanying drawings are incorporated herein and form a part of the specification.

FIG. 1 is a block diagram illustrating functionality for an encryption and key transfer system (KTS), according to some example embodiments.

FIG. 2 is a block diagram illustrating an example key hierarchy, according to some example embodiments.

FIG. 3 is a flowchart illustrating example operations for functionality for an encryption and key transfer system (KTS), according to some embodiments.

FIG. 4 is a flowchart illustrating example operations for functionality for a target database server of a key transfer system (KTS), according to some embodiments.

FIG. 5 is a flowchart illustrating example operations for functionality for a source database server of a key transfer system (KTS), according to some embodiments.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Data is often transferred between different databases for various reasons. For example, data may be transferred from a source server to a target server because of a scheduled data migration, equipment upgrade, or as part of a testing environment. To protect the integrity of the data being transferred, the data may be encrypted using encryption keys or secrets. But, in order for the target server to actually access the data, the encryption keys must also be transferred from the source server to the target server. However, simply transmitting the encryption keys over an unsecure network could expose the encryption keys, and as a result the underlying data, to the same security threats which were originally sought to be avoided by encrypting the data in the first place.

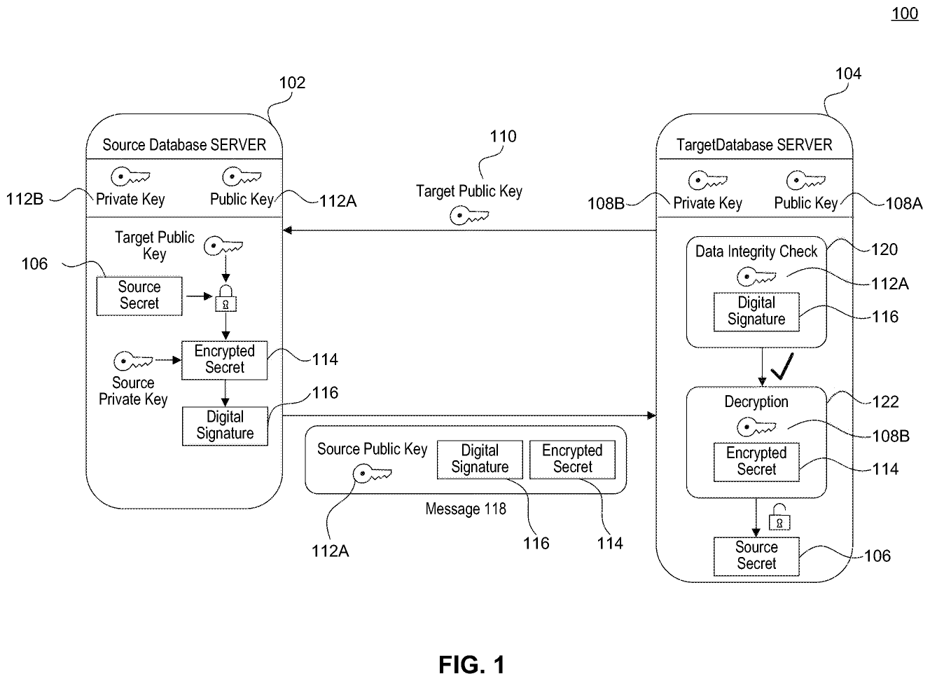

FIG. 1 is a block diagram 100 illustrating functionality for an encryption and key transfer system (KTS), according to some example embodiments. In some embodiments, the KTS may include both a source database server 102 (referred to herein as source 102) and a target database server 104 (referred to herein as target 104).

In some embodiments, source 102 may be a computing device (or a group of multiple computing devices) that stores or has access to (at least partly encrypted) data. This data may be transferred or otherwise made available to target 104. Target 104 may be a computing device (or a group of computing devices) that receives the data or at least access to the data, including the encrypted data, from source 102. However, for target 104 to access the encrypted portions of the data, target 104 may require access to one or more encryption keys, referred to herein as source secret 106 (or secret 106). In some embodiments, source 102 and target 104 can be of the same or different database server types. Example database server types include but are not limited to SAP Adaptive Server Enterprise (ASE), SAP IQ, and SAP HANA databases.

In some embodiments, source 102 and target 104 may be database servers that are communicatively coupled over a communications network, such as a private intranet or the Internet. In some embodiments, communications between source 102 and target 104 may include passage through intermediary computing devices, servers, routers, etc.

In some embodiments, the data (including the encrypted data) may be copied or transferred from source 102 to target 104. In some embodiments, target 104 may be a computing device (e.g., such as a mobile phone or laptop) that is provided access or permissions to access the data stored at source 102 or on another computing device. In some embodiments, target 104 may be a mobile device with its own local copy of a portion of the data of source 102 that it needs to access.

The encrypted data may have been encrypted using any varying number or types of encryption schemes. For example, the data may include a first table encrypted using a first encryption scheme, a first column of a second table encrypted using a second encryption scheme (in which the rest of the table is not encrypted), and a third table with all unencrypted data. In some embodiments, the data may be stored across various files, databases, or computing devices—which may each have its own unique encryption scheme.

When the encrypted data is transferred from source 102 to target 104, target 104 may need the encryption key(s) to unencrypt (or decrypt) and access the encrypted data. However, there are security issues with transferring sensitive data, such as encryption keys, over a communications network. For example, the data transfer may intercepted by or interfered with (e.g., changed) by hackers, which may expose both the encryption keys and underlying data to the same risks that were sought to be avoided by encrypting the data in the first place. KTS provides a system for the secure transfer of encryption keys between two or more computing devices over any communications network.

Source 102 may include or store a source secret 106, referred to herein as secret 106. Secret 106 may refer to one or more encryption keys that were used to encrypt data. As noted above, the encrypted data may have been or may be transferred from one computing device to another computing device. In some embodiments, the transfer of encrypted data may be between source 102 and target 104, while in other embodiments, the transfer of encrypted data may be between different computing devices, and source 102 and target 104 are used to transfer secret 106 (over one or more unsecured communications networks).

In some embodiments, KTS may use public-key cryptography or key pairs as part of ensuring secure key transfer between devices. For example, target 104 may generate its own target key pair, including both a target public key 108A (that may be shared with another computing device, such as source 102) and a target private key 108B (that is stored locally and not shared). In some embodiments, source 102 may also generate its own source key pair, including both a source public key 112A (that may be shared) and a source private key 112B (that is stored locally and not shared).

As used herein, either public keys 108A, 112A or private keys 108B, 112B may be used to encrypt or decrypt data. For example, data encrypted with target public key 108A may be decrypted with corresponding target private key 108B. Similarly, data encrypted with source private key 112B may be decrypted with source public key 112A. As noted above, one difference between the public and private keys may be that the public keys 108A, 112A may be shared with another computing device. RSA (Rivest-Shamir-Adeleman) is an example of a public-key cryptosystem which may be used, in part, to generate keys and secure a data transmission.

As illustrated at 110 of FIG. 1, target public key 108A may be shared with or transferred to source 102. In some embodiments, target 104 may submit a request for secret 106 and provide target public key 108A with the request.

In some embodiments, source 102 may use the target public key 108A (provided at 110) to encrypt secret 106 and generate an encrypted secret 114. Encrypted secret 114 may include the one or more encryption keys (of secret 106), used to encrypt data to which target 104 has been provided access, encrypted using the target public key 108A. In some embodiments, data encrypted using target public key 108A may only be decrypted using the corresponding target private key 108B.

In some embodiments, source 102 may use the source private key 112B to further encrypt the encrypted secret 114 to generate a digital signature 116. Digital signature 116 may be an example of asymmetric cryptography. Digital signature 116 may be used to authenticate the source of a message and may provide the recipient a strong reason to believe that the message 118 was created by a known sender (e.g., source 102). Digital signature 116 may be used to provide confidence that a message has not been altered or changed during transmission (particularly when transmission occurs over a public or insecure network), protecting or verifying the integrity of the data of message 118.

While encryption may hide the content of a message, it may be possible for a hacker to change an encrypted message without understanding it. If a message 118 is digitally signed, any change in the message 118 after the digital signature 116 will invalidate the signature. There is no efficient way to modify a message 118 and its digital signature 116 to produce a new message and a valid signature. As such, the digital signature 116 may increase both authenticity of the source and integrity of the message 118.

In some embodiments, source 102 may secure a message 118, including encrypted secret 114 and source public key 112A, with digital signature 116 using source private key 112B. And this message 118 may be transmit to target 104. As noted above, the digital signature 116 may ensure that the contents of message 118 are not changed during transit.

In some embodiments, target 104 may perform a data integrity check 120 after receiving message 118. In performing Data integrity check 120, target 104 may verify that digital signature 116 is still valid with source public key 112A. If the digital signature 116 is not valid, target 104 may discard the message 118 and request the secret 106 again. In some embodiments, re-sending the secret 106 may cause target 104 and/or source 102 to generate new key pairs.

If the digital signature 116 is valid, then target 104 may use target private key 108B to unencrypt encrypted secret 114 received through message 118 and access source secret 106. Target 104 may then use secret 106 to unencrypt and access (e.g., read, write, delete, modify) the encrypted data.

The key transfer system (KTS) described herein may enable for the secure transfer of encryption keys from one database or computing device to another without requiring the use of passwords (that would be provided by a user and that must remembered by the user or administrator).

For example, generally speaking, a transfer encryption key command (e.g., in SQL (structured query language) or another computing language) may require a user supplied password. Then, for example, an administrator of a source computer may pick a password, which must still be communicated to an administrator of a target computer to receive the encryption keys. However, this process is subject to human errors by either administrator (which may include entering the wrong password, forgetting the password, picking an unsecure password, sharing password, storing password at unsecure place, revealing password to others, etc.). Furthermore, the key file that is transferred may still be changed by a hacker or transmission error even if it encrypted and there is no way for an administrator at the target computer to know. Also, human-generated passwords are easy to guess/crack, especially relative to encryption keys and public-private key pairs.

A further limitation of this general approach is that if there are multiple source devices, each of which may have transferred encrypted data or keys, it is impossible to identify which source device sent which key file. By contrast, KTS may ensure confidentiality without the need for user passwords, integrity that avoid the files being hacked during transit, and authentication of the source 102 from which a message 118 is received.

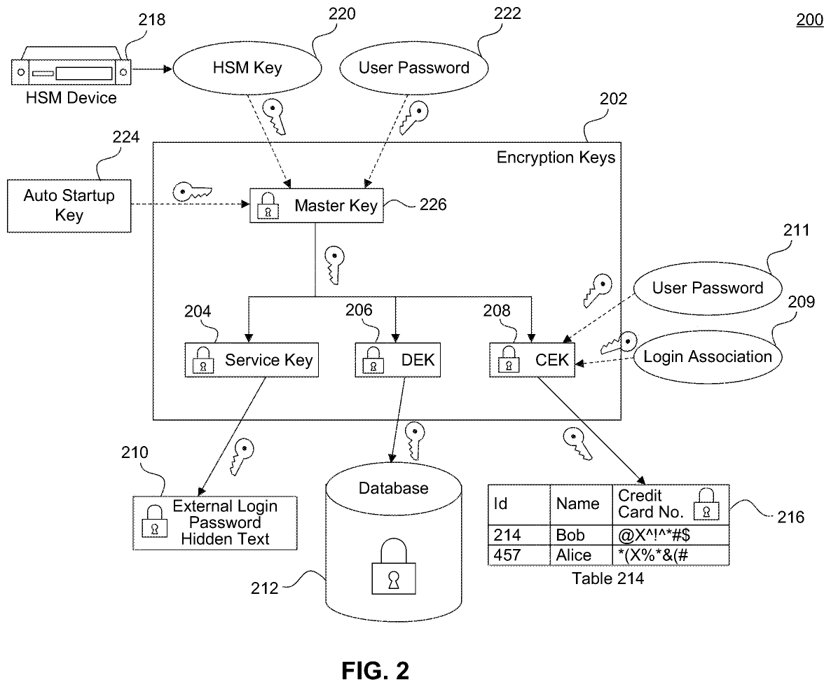

FIG. 2 is a block diagram 200 illustrating an example key hierarchy 202, according to some example embodiments. Key hierarchy 202 illustrates an example arrangement or organization of various encryption keys, and various other confidential information (e.g., such as usernames, passwords, login credentials, etc.), as may be arranged by a key transfer system (KTS). Key hierarchy 202 is an example of how multiple keys and passwords may be organized and transmit by KTS as a single secret 106 as described herein. In other embodiments, they keys and passwords may be arranged into multiple key hierarchies 202 and transmit as multiple secrets 106.

As used herein, the term “key” may refer to a piece of information, such as a string of alphanumeric text stored in a file that when passed through a cryptographic algorithm, can be used to encode or decode cryptographic data. The keys may be of different sizes and be used with different encryption protocols. Passwords may be user-generated or auto-generated strings that are used by users (often with userids) to login and/or access a system, data, or particular functionality.

Service key 204 that may be used to encrypt external login passwords and/or hidden text 210. Database encryption key (DEK) 206 may be used to encrypt an entire database, part of a database, or one or more tables or objects of a database 212. Database 212 may include any storage mechanism, memory, including either column-oriented or row-oriented databases, and may include various portions of a database, such as a table, row, or view.

Column encryption key (CEK) 208 may be used to encrypt a particular column 216 of a table 214 of a database (e.g., 212). For example, a particular table 214 may include multiple columns, where only a subset of the columns 216 are encrypted. In some embodiments, all the encrypted columns may use the same CEK 208, in other embodiments, each column 216 may include its own unique CEK 208. In some embodiments, database 212 may be encrypted with DEK 206, and various columns of database 212 may also be further encrypted with their own CEKs 208. As illustrated, in some embodiments, a CEK 208 may further be encrypted with user passwords 211 or login association 209 passwords used to authenticate the user to the database server. A list of user passwords 211 and/or userids or login association 209 passwords may be necessary to unencrypt or otherwise access the encrypted column 216.

In some embodiments, master key 226 may be a cryptographic key used to encrypt or protect other keys, or may be used to generate other keys while those keys are in storage, in use, or in transit like service key 204, DEK 206 and CEK 208. Master key 226 can further be encrypted with another encryption keys like HSM Key 220 and/or user password 222 forming a key hierarchy in the database system. HSM Key 220 may reside in its own HSM Device 218 outside of database system.

As illustrated, in some embodiments, access to master key 226 is needed in order to decrypt the service key 204, DEK 206 and CEK 208, and underline encrypted data. To avoid human intervention to supply the user password 222 to access the master key 226, some embodiments can save a copy of master key 226 into auto startup key 224 file and database server will access the master key from the auto startup key 224 directly in order to decrypt other keys and underline encrypted data.

As described herein, the master key 226 may be transmit by KTS as source secret 106. In some embodiments, KTS may transmit multiple master keys 226 and/or multiple other encryption keys such as service key 204, DEK 206, and CEK 208 (in addition or in lieu of a master key 226) as multiple secrets 106.

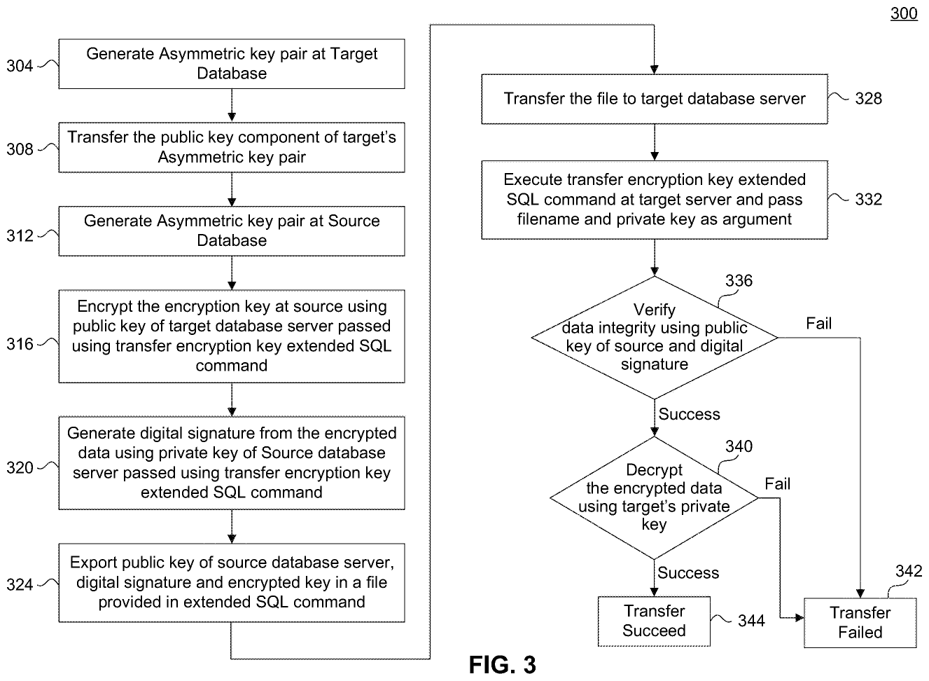

FIG. 3 is a flowchart 300 illustrating example operations for functionality for an encryption and key transfer system (KTS), according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to the figures.

At 304, an asymmetric key pair is generated at a target database. For example, target 104 may generate a target public key 108A and a target private key 108B. Target public key 108A may be shared with other computing devices, such as source 102, while target private key 108B may remain secured at target 104 without being transferred over a communications network and exposed to potential threats.

At 308, the public key component of target's asymmetric key pair may be transferred. For example, at 110 of FIG. 1, target public key 108A may be transferred from target 104 to source 102 over an unsecured communications network, such as the Internet.

At 312, an asymmetric key pair is generated at a source database. For example, source 102 may generate source public key 112A and source private key 112B. Source public key 112A may be shared with other computing devices, such as target 104, while source private key 112B may remain secured by source 102 without being transferred over a communications network and exposed to potential threats.

At 316, the encryption keys are encrypted at source using the public key of target database server passed using transfer encryption key extended SQL command. For example, source 102 may encrypt the encryption key (e.g., source secret 106) using the ENCRYPT WITH command argument target public key 108A that was transferred at 110.

At 320, the digital signature is generated from the encrypted data using the private key of source database server passed using transfer encryption key extended SQL command. For example, source 102 may generate digital signature 116 using the SIGNED WITH command argument specifying the source private key 112B.

TRANSFER ENCRYPTION KEY [[<database_name>.] <owner>.] {<keyname>}
ENCRYPT WITH ‘<public key of target's asymmetric key pair>’
SIGNED WITH ‘<private key of source's asymmetric key pair>’
TO <filename>

The keyname may be the name of the encryption key (e.g., master key 226) to be transferred, migrated, exported, or imported. The filename may be the name of the file used to store the encrypted key copy, digital signature, and/or the source public key 112A.

At 324, the public key of source database server, digital signature, and encrypted key are exported in a file provided in extended SQL command. For example, source public key 112A, digital signature 116, and encrypted secret 114, and may be exported to a message 118.

At 328, the file is transferred to target database server. For example, message 118 may be provided by source 102 to target 104 over one or more secure or unsecured communications networks, signed with digital signature 116.

At 332, the transfer encryption key extended SQL command is executed at the target server where the file name and private key are passed as arguments. In some embodiments, file name may be passed with FROM argument and private key is passed with DECRYPT WITH argument. For example, target 104 may use the following SQL commands:

TRANSFER ENCRYPTION KEY [[<database_name>.] <owner>.] {<keyname>}
DECRYPT WITH ‘<private key of target's asymmetric key pair>’
FROM <filename>

At 336, the data integrity is verified using the public key of the source and the digital signature. For example, at 120 of FIG. 1, target 104 may use the source public key 112A to decrypt and verify that the digital signature 116 is still valid, which indicates the message 118 was not tampered with during the transit from source 102 to target 104, which verifies the data integrity. If the digital signature 116 is no longer valid, then the transfer would fail at 342. The transfer may then be restarted from the beginning or abandoned altogether.

At 340, the encrypted data is decrypted using the target's private key. For example, if the digital signature 116 is valid and the data integrity check 120 succeeds, target may perform decryption 122 using target private key 108B. If the decryption process fails, then the transfer would be deemed a failure at 342 and the users or administrators may be notified and/or the process may be restarted. If the decryption succeeds, target 104 has access to source secret 106 which may be used to decrypt the transferred encrypted data (e.g., as illustrated in FIG. 2).

At 344, if the encrypted secret 114 is successfully unecrypted at 122, then target 104 has access to secret 106 which may be used to unencrypt various data. As illustrated in FIG. 2, the secret 106 may include a master key 226 that provides access to a variety of different keys that may be used for decryption purposes, including, for example, a DEK 206 that may be used to decryption and access a database 212.

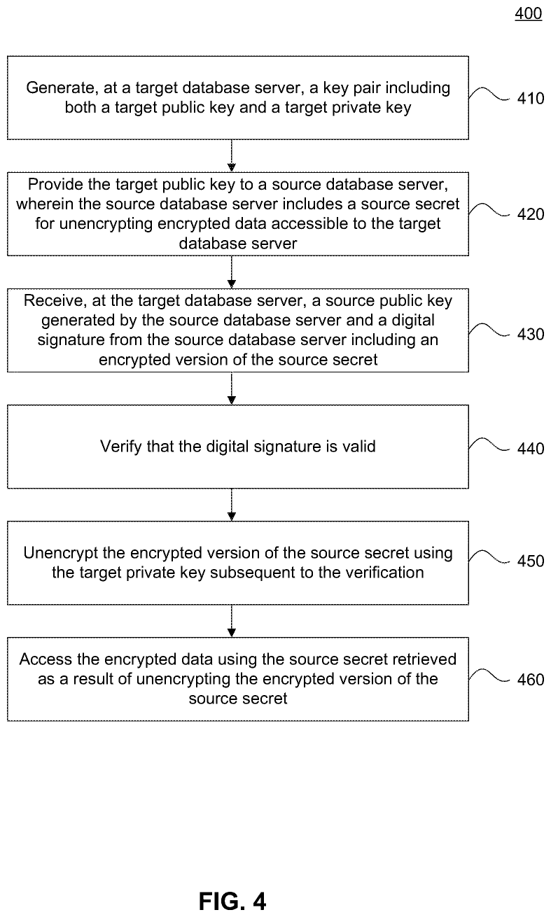

FIG. 4 is a flowchart 400 illustrating example operations for functionality for a target database server of a key transfer system (KTS), according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to the figures.

In 410, a key pair including both a target public key and a target private key is generated at a target database server. For example, target 104 may generate a target public key 108A and a target private key 108B.

In 420, the target public key is provided to a source database server. For example, at 110, the target public key 108A is provided to source 102. Source 102 may include a source secret 106 that was used to encrypt data that was or is to be transferred or otherwise made accessible to target 104.

In 430, a source public key generated by the source database server and a digital signature from the source database server including an encrypted version of the source secret are received at the target database. For example, target 104 may receive message 118 including source public key 112A, digital signature 116, and encrypted secret 114.

In 440, the digital signature is verified as being valid. For example, target 104 may use source public key 112A to access digital signature 116 and perform the data integrity check 120.

In 450, the encrypted version of the source secret is unencrypted using the target private key subsequent to the verification. For example, if data integrity check 120 succeeds, target may unencrypt the encrypted secret 114 using the target private key 108B.

In 460, the encrypted data is accessed using source secret retrieved as a result of unencrypting the encrypted version of the source secret. For example, secret 106 may extracted from encrypted secret 114 and may reveal a variety of different keys (as illustrated in FIG. 2), which may be used to decrypt various portions of data that were encrypted. Target 104 may use a DEK 206 or CEK 208 to access encrypted data from a database 212 to which target 104 has access.

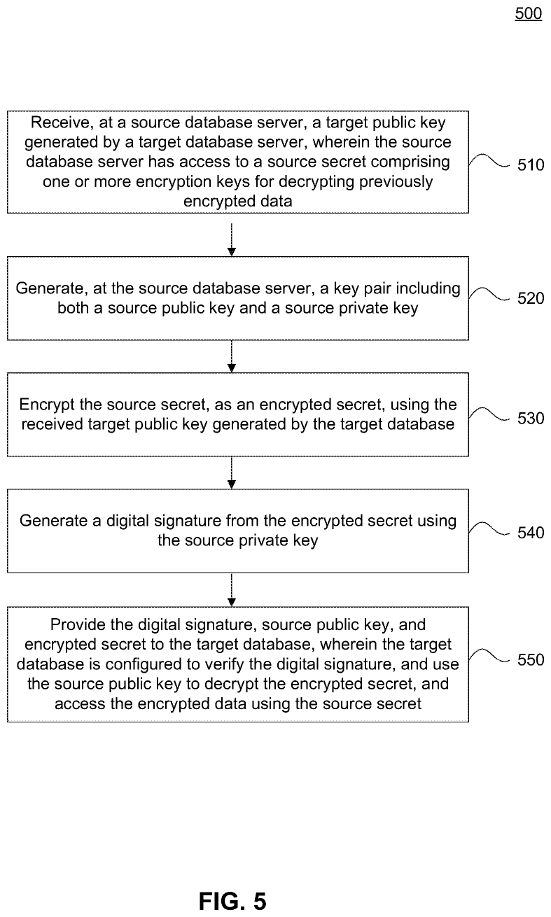

FIG. 5 is a flowchart 500 illustrating example operations for functionality for a source database server of a key transfer system (KTS), according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 500 shall be described with reference to the figures.

In 510, a target public key generated by a target database server is received at a source database server, wherein the source database server has access to a source secret comprising one or more encryption keys for decrypting previously encrypted data. For example, source 102 may store secret 106 and may receive target public key 108A which source 102 may interpret as a request for secret 106. In some embodiments, at 110, source 102 may receive both a request and target public key 108A with the request for secret 106.

In 520, a key pair, including both a source public key and a source private key, is generated at the source database server. For example, source 102 may generate both source public key 112A and source private key 112B.

In 530, the source secret is encrypted, as an encrypted secret, using the received target public key generated by the target database. For example, source 102 may encrypt secret 106 with target public key 110A to generate encrypted secret 114.

In 540, a digital signature is generated from the encrypted secret using the source private key. For example, using source private key 112B, source may generate digital signature 116 with encrypted secret 114.

In 550, the digital signature, source public key, and encrypted secret are provided to the target database, wherein the target database is configured to verify the digital signature, and use the source public key to decrypt the encrypted secret, and access the encrypted data using the source secret. For example, source may provide message 118, including source public key 112A and encrypted secret 114, secured with digital signature 116 to target 104. Target 104 may then perform a data integrity check 120 and decryption 122 to access the source secret 106 which may be used to unlock, decrypt, or unencrypt and access encrypted data or other information.

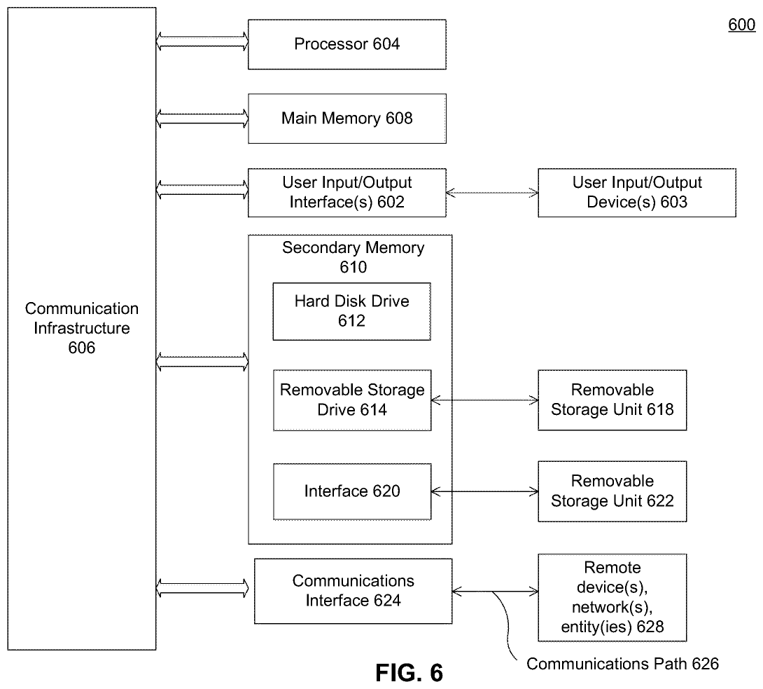

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include customer input/output device(s) 603, such as monitors, keyboards, pointing devices, etc., which may communicate with communication infrastructure 606 through customer input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random-access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” and/or cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “some embodiments” “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
generating, at a target database server, a key pair including both a target public key and a target private key;
providing the target public key to a source database server, wherein the source database server includes a source secret for unencrypting encrypted data accessible to the target database server;
receiving, at the target database server, a source public key generated by the source database server and a digital signature signed with a source private key generated by the source database server including an encrypted version of the source secret;
verifying that the digital signature is valid;
unencrypting the encrypted version of the source secret using the target private key subsequent to the verification; and
accessing the encrypted data using the source secret retrieved as a result of unencrypting the encrypted version of the source secret.

2. The method of claim 1, wherein the source database server is configured to generate both the source public key and the source private key.

3. The method of claim 1, wherein the digital signature comprises the encrypted version of the source secret that was encrypted using the source private key.

4. The method of claim 1, wherein the source secret comprises multiple keys for unencrypting various portions of the encrypted data.

5. The method of claim 4, wherein the multiple keys are arranged into a key hierarchy.

6. The method of claim 1, wherein the key pair comprises a Rivest-Shamir-Adleman (RSA) key pair.

7. The method of claim 1, further comprising:
determining that the encrypted version of the source secret was encrypted by the source database server using the target public key.

8. A system, comprising:
a memory; and
at least one processor coupled to the memory and configured to perform instructions that cause the at least one processor to perform operations comprising:
generating, at a target database server, a key pair including both a target public key and a target private key;
providing the target public key to a source database server, wherein the source database server includes a source secret for unencrypting encrypted data accessible to the target database server;
receiving, at the target database server, a source public key generated by the source database server and a digital signature signed with a source private key generated by the source database server including an encrypted version of the source secret;
verifying that the digital signature is valid;
unencrypting the encrypted version of the source secret using the target private key subsequent to the verification; and
accessing the encrypted data using the source secret retrieved as a result of unencrypting the encrypted version of the source secret.

9. The system of claim 8, wherein the source database server is configured to generate both the source public key and the source private key.

10. The system of claim 8, wherein the digital signature comprises the encrypted version of the source secret that was encrypted using the source private key.

11. The system of claim 8, wherein the source secret comprises multiple keys for unencrypting various portions of the encrypted data.

12. The system of claim 11, wherein the multiple keys are arranged into a key hierarchy.

13. The system of claim 8, wherein the key pair comprises a Rivest-Shamir-Adleman (RSA) key pair.

14. The system of claim 8, the operations further comprising:
determining that the encrypted version of the source secret was encrypted by the source database server using the target public key.

15. A non-transitory computer-readable medium having instructions stored thereon that, when executed by at least one computing device, cause the at least one computing device to perform operations comprising:
generating, at a target database server, a key pair including both a target public key and a target private key;
providing the target public key to a source database server, wherein the source database server includes a source secret for unencrypting encrypted data accessible to the target database server;
receiving, at the target database server, a source public key generated by the source database server and a digital signature signed with a source private key generated by the source database server including an encrypted version of the source secret;
verifying that the digital signature is valid;
unencrypting the encrypted version of the source secret using the target private key subsequent to the verification; and
accessing the encrypted data using the source secret retrieved as a result of unencrypting the encrypted version of the source secret.

16. The non-transitory computer-readable medium of claim 15, wherein the source database server is configured to generate both the source public key and the source private key.

17. The non-transitory computer-readable medium of claim 15, wherein the digital signature comprises the encrypted version of the source secret that was encrypted using the source private key.

18. The non-transitory computer-readable medium of claim 15, wherein the source secret comprises multiple keys for unencrypting various portions of the encrypted data.

19. The non-transitory computer-readable medium of claim 18, wherein the multiple keys are arranged into a key hierarchy.

20. The non-transitory computer-readable medium of claim 15, wherein the key pair comprises a Rivest-Shamir-Adleman (RSA) key pair.
